(19) United States
(12) Patent Application Publication
(10) Pub. No.: US 2012/0187748 A1
(43) Pub. Date: Jul. 26, 2012

(54) Low friction wheel for toy cars

(76) Inventor: Thomas Alan Davis, Sunnyvale, CA (US)

(21) Appl. No.: 12/930,991

(22) Filed: Jan. 21, 2011

(51) Int. Cl. B60B 21/00; B60B 27/00

(52) U.S. Cl. 301/95.101

(57) ABSTRACT

A wheel for toy cars with a threaded bore. The threaded bore provides a low friction surface between the wheel and axel, and enables a custom fit to axel through thread deformation.

### BACKGROUND OF THE INVENTION

1. Field of the Invention

The present invention relates generally to providing a low friction wheel used on toy cars. This is done by having a threaded wheel bore as opposed to a smooth wheel bore. Additionally the threaded wheel bore can allow a custom fit between the wheel bore and axel.

2. Background of the Invention

Toy cars are used in a wide variety of games and activities. In some toy car competitions, the toy cars are raced down a sloped track, using only gravity to provide their kinetic energy. Examples of toy cars include Boy Scouts of America Pinewood Derby and PineCar Racer toy cars. The present invention is not limited to use on these cars, but can be applied generally to toy cars. To enhance the performance of toy cars, it is a common practice to improve performance by reducing friction between the wheel and axel. Axels for these cars are made from small nails that are inserted into the wheel bore and affixed to the body of the car. The wheel spins on the nail shaft, therefore the nail acts as a wheel axel. The head of the nail prevents the wheel from falling off of the axel. Wheels are typically made of plastic, but may be made from other materials such as metal.

The wheel axel is commonly made from a nail with a shaft, and head. The process of nail manufacture produces flashing on the nail head, and crimp marks on the axel. These elements are rough and produce friction when the wheel spins on the axel, therefore are removed in performance tuning of the axel. The axel may also have a groove cut into it to reduce contact surface area between the wheel and axel.

Performance tuning of axels includes removing defects on the nail head, and shaft, polishing the nail head and nail shaft, and providing a grooved section on the nail shaft (axel). This performance tuning can be done in a machining process or by hand tools. Performance tuning of axels is often done by a rotary trimming and polishing process using a lathe or drill. During this process the axel diameter is most often reduced. Manufactured axels may have varied diameters, and the process of performance tuning axels can also contribute to varied axel diameters which lead to the need for custom fitting the wheel to the axel.

It is also possible to manufacture a wheel with a threaded wheel bore as a method to reduce wheel to axel contact area. A threaded wheel bore has the advantage of a very low wheel to axel contact. Threaded wheel bore diameters can be manufactured to optimize the clearance between the axel and wheel that will not require custom fitting processes by ensuring a clearance fit between the wheel and axel. To provide a custom fit between the wheel and axel the wheel bore may be smaller in diameter than the axel providing interference fit. For such situations the wheel bore threads are deformed through upon insertion of the axel providing a custom fit. Thread deformation is relatively easy to perform as only a small amount of material from the thread crest is deformed. The weight of the car on the rolling wheels will allow for little thread deformation. Should the wheel bore to axel clearance remain to insufficient the wheel will not spin freely. To increase wheel to axel clearance pressure from the wheel perpendicular to the axel during wheel rotation will deform the threads within the wheel bore and provide additional wheel to axel clearance and will allow the wheel to spin freely. Alternatively, tools may be used to burnish or ream the wheel bore to a desired diameter that permits the wheel to rotate freely. Polishing and lubricating the wheel bore to reduce friction may be done also. Reaming and or burnishing of thread crests during manufacturing or tuning to increase wheel bore diameter may flatten or trim the thread crests, yet can still provide a low wheel to axel contact area, and therefore a low friction wheel.

Performance tuning of the wheel bore options included reaming and or burnishing the bore to provide a preferred axel to wheel clearance, and polishing the wheel bore. This can be done for wheels with a smooth or threaded bore.

Prior art wheels are of one piece construction, and have a smooth bore.

Prior art wheels have several shortcoming of a smooth bore that has a high axel to wheel surface contact area which will have greater friction than that of a wheel with low axel to wheel surface contact area. Prior art wheel do not allow for an easy custom fit between axel and wheel. Wheel bores and axels that have excessive clearance may vibrate or flutter when spinning on the axel, slowing the wheel. When using a threaded wheel bore, it is not necessary to use a grooved axel to reduce wheel to axel contact area. Using both a threaded wheel bore and grooved axel is possible to minimize wheel to axel contact area.

The present invention provides a threaded wheel bore that overcomes the weaknesses of prior-art, providing a dual function low friction surface between the wheel and axel, and ability to enable a custom fit between the axel and wheel by deforming the thread crests.

### SUMMARY

In one embodiment, a wheel with a threaded bore, hub, rim and tread. The wheel is preferably made of one piece construction.

These features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic cross-section a toy car wheel that may be improved by application of the present invention.

FIG. 2 shows a diagram of the axel used on toy cars as described.

The drawings are not necessarily drawn to scale.

### DETAILED DESCRIPTION

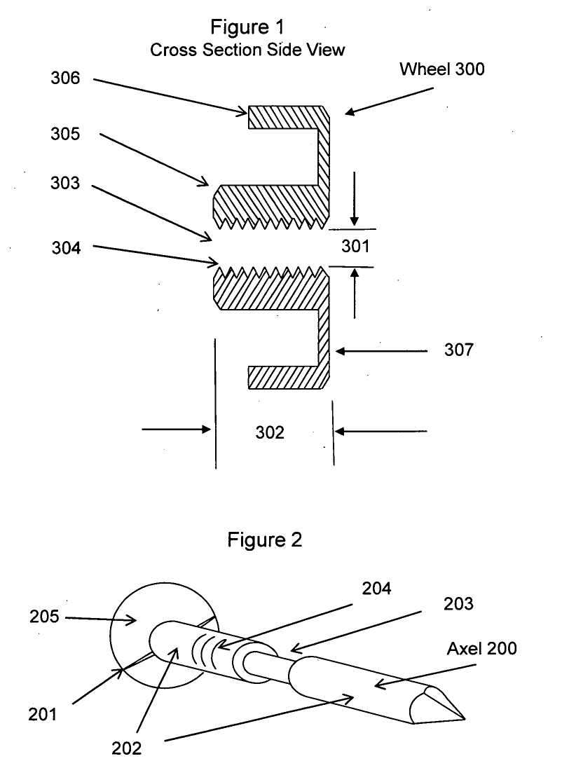

FIG. 1 shows a schematic cross-section of one embodiment of the present invention. Low friction wheel for toy cars 300 includes a wheel bore 303 (i.e. the hole through which a toy car axel is placed), and threads 304. The wheel bore has a wheel bore diameter 301 and a wheel bore length 302. The wheel bore is suggested to be constant in diameter through the wheel bore length. The wheel bore threads 304 are suggested to be of standard machine threads. The hub 305 is connected to the wheel rim 307, and wheel tread 306. The hub may have a chamfered or rounded edge and is concentric about the wheel bore. The rim is connected to the hub, and supports the tread. The hub, rim and tread shall be symmetrical providing balance upon rotation of the wheel. The present invention is preferably made of one piece construction. In other words, sections 301, 302, 303, 304, 305, 306, and 307 are not easily separated from each other, and are all preferably formed from the same piece of material.

FIG. 2 shows a diagram of the wheel axel 200. The wheel axel is commonly made from a nail with a shaft 202, and head 205. The process of nail manufacture produces flashing on the nail head 201, and crimp marks 204 on the axel. These elements are rough and produce friction when the wheel spins, therefore are removed in performance tuning of the axel. The axel 200 may have a groove 203 cut into the shaft 202 to reduce contact surface area between the wheel and axel.

1. A low friction wheel for toy cars comprising:
A threaded wheel bore, hub, rim, and tread.

2. The threaded wheel bore of claim 1 wherein the threads are continuous through the wheel bore; the wheel bore is of equal diameter throughout its length.

3. The threaded wheel bore of claim 1 wherein the wheel bore threads are suggested to be of typical machine threads.

4. The threaded wheel bore of claim 1 wherein the wheel bore diameter is suggested to be slightly smaller than the wheel axel to allow for a custom fit between the threaded wheel bore and axel. A custom fit between the axel and threaded wheel bore is achieved by inserting the axel into the wheel bore, and rotating the wheel on the axel. Application of pressure on the wheel perpendicular to the axel during wheel rotation will burnish the threads providing necessary clearance between the wheel bore and axel.

5. The threaded wheel bore of claim 1 wherein the wheel bore thread diameter may be burnished, and or reamed to increase the wheel bored diameter.

6. The hub of claim 1 wherein may have a chamfered or rounded edge to minimize surface contact with the car body to reduce friction.

7. The rim of claim 1 wherein a design of the rim may include decorative designs such as a wheel hub cap, tire, tire tread, numbers, letters or designs for appearance purposes.

8. The tread of claim 1 wherein the design of the tread may be smooth, grooved, or otherwise configured to reduce friction.

9. The tread of claim 1 wherein the tread may be decorative in nature.

10. The tread of claim 1 wherein the tread mass is reduced to minimize energy needed to rotate the wheel.

11. The threaded wheel bore of claim 1 wherein the threaded wheel bore; hub, rim, and tread are symmetrical in design or consistent in shape to allow the wheel to remain in balance during rotation. These elements shall be concentric about the wheel axis.

12. The rim of claim 1 wherein a smooth recess is provided for the axel head minimizing friction between the axel and wheel during wheel rotation.

13. The threaded wheel bore, hub, rim, and tread (wheel) of claim 1 wherein are typically made of plastic, but may be made from other materials such as metal. These parts are suggested to be of one piece construction.

14. The rim of claim 1 wherein may be positioned at any location along the hub.

15. The threaded wheel bore of claim 1 wherein may be slightly smaller than the axel providing the desired threaded wheel bore to axel fit without custom fitting or additional fitting actions.

16. The threaded wheel bore of claim 1 wherein may have threads that have thread crests that are flat or rounded.

17. The hub, rim, and tread (wheel) of claim 1 wherein has a design to minimize wheel weight, thereby reducing rotational energy required to roll the wheel. Weight reduction strategies include minimizing the thickness of these elements. Additional strategies may include eliminating the tread entirely whereby the wheel rolls only upon the wheel rim. The circumference of the rim becomes in effect the wheel tread.

18. The rim of claim 1 wherein may contain perforations reduce weight of the rim, therefore reduce rotational energy need to spin the wheel for wheel rotation. Perforations must remain symmetrical about the wheel axis so the wheel remains in balance during wheel rotation.
